(19) United States
(12) Patent Application Publication
(10) Pub. No.: US 2009/0060230 A1
(43) Pub. Date: Mar. 5, 2009

(54) ELECTROMECHANICAL TRANSDUCER AND A PRODUCTION METHOD

(75) Inventors: Terho Kutilainen, Kiiminki (FI); Dewei Tian, Kerava (FI)

Correspondence Address: BIRCH STEWART KOLASCH & BIRCH, PO BOX 747, FALLS CHURCH, VA, 22040-0747, US

(73) Assignee: Perlos Technology Oy, Vantaa (FI)

(21) Appl. No.: 10/562,038

(22) PCT Filed: Jun. 23, 2004
(86) PCT No.: PCT/FI2004/000382

§ 371 Date: Nov. 14, 2008

(30) Foreign Application Priority Data
Jun. 25, 2003 (FI) 20030945

(51) Int. Cl. H04R 1/00; H04R 31/00

(52) U.S. Cl. 381/150; 29/594; 29/602.1

(57) ABSTRACT

The invention relates to an electromechanical transducer and a method for manufacturing the transducer. The transducer includes a membrane (3), two electrodes (1, 2), the electric field between which can be controlled or measured, and a support structure (4, 5), on which the membrane (3) is arranged to vibrate interactively with the electric field. According to the invention, the support structure (4, 5) includes several support points (4, 5), which are aligned in such a way that several parallel vibrators are formed in the membrane (3).

The present invention relates to an electromechanical transducer, which converts sound energy into electrical signals, or vice versa. In particular, the invention relates to a transducer according to the preamble of Claim 1.

The invention also relates to a method, according to the preamble of Claim 12, for manufacturing an electromechanical transducer.

A typical electromechanical transducer is a loudspeaker or a microphone. For example, in portable telecommunications devices, such as mobile telephones, there are a microphone and a loudspeaker. A typical mobile telephone microphone is an electret microphone. The loudspeaker typically includes a voice coil or a piezoelectric element.

One goal of mobile telephone product development is to integrate the components contained in the device more compactly than at present in the mechanical structures of the device, such as the case of the telephone. This development aims to create smaller and lighter devices and simpler and more cost-effective manufacturing methods.

In a solution representing the closest prior art, a charged membrane is supported at its edges and located at a suitable distance from electrodes, which may be on one or both sides of the membrane. European patent publication EP 1 244 053 discloses a mobile telephone loudspeaker and microphone, which utilize a self-charging insulating polymer membrane. In the solution disclosed in the publication, the electromechanical dielectric (EMD) membrane is supported at its edges and integrated with the surface of the case. When acting as a loudspeaker, the EMD membrane converts the electrical signal, connected to it from an electrical circuit via metal electrodes, into sound energy, by vibrating backwards and forwards. Correspondingly, when acting as a microphone, the EMD membrane converts sound energy into an electrical signal.

The present invention is intended to create a highly-developed and economical transducer and manufacturing method, with the aid of which the transducer can be integrated as part of some other structure, for example, the case structure of the device.

The invention is based on the idea that the transducer includes several parallel transducer elements. Thus, according to the invention, the vibrating membrane is located between the spheres of influence of two electrodes, in such a way that the membrane is supported at several points with the aid of a support structure, so that the membrane has several support points, in the area between which the membrane can vibrate. Thus the transducer is formed from several parallel vibrators, which interact with the electrodes. Further, the support structure is arranged in such a way that a vibration space remains on both sides of the membrane, which permits the membrane to vibrate in the directions of both surfaces of the membrane.

In some embodiments, the membrane is pressed against at least one electrode, with the aid of ridges arranged between the membrane and the electrode structure. Thus, the parts of the membrane remaining between the ridges can vibrate. The ridges can be formed, for example, in one electrode, in both electrodes, in a support structure external to the electrodes, in the actual vibrating membrane, or in a separate adapter structure, which is located between the membrane and the support surface.

In some embodiments, the cavities surrounding the membrane are connected to the external air or to a large air space, with the aid of openings or channels, so that the compression of the air in the cavities will not create resistance to vibration. In some embodiments, these openings or channels can also have a favourable effect on the progression of sound between the vibrating membrane and the environment of the transducer. In some embodiments, the openings or channels are formed in the electrode structure.

In embodiments of the invention, the electrode, against which the membrane is arranged with the aid of support structures, is typically manufactured to be relatively rigid, so that vibration mainly takes place in the vibrating membrane, while the said electrode remains essentially immobile. Thus the material of the said electrode is selected so as to be sufficiently rigid relative to the membrane. The material of the electrode itself can be conductive, or it can be surfaced to be conductive. The electrode material is also preferably such that openings can be formed in it, or channels can be formed between the membrane and its environment.

In some embodiments, the support structures and the electrode surfaces delimit vibration spaces, i.e. cavities, in order to permit vibration of the membrane. The support structures then form raised patterns, such as a column, beam, or grid matrix parallel to the surface of the membrane, so that a group of parallel vibration spaces are created. The raised patterns can also be irregular. The vibration spaces as such can be either connected to each other or separate.

More specifically, the transducer according to the invention is characterized by what is stated in the characterizing portion of Claim 1.

The manufacturing methods according to the invention are, in turn, characterized by what is stated in the characterizing portions of Claims 12 and 16.

Considerable advantages are gained with the aid of the invention. The use of the invention will achieve a transducer element that requires little space and has a simple manufacturing method.

The invention also has many preferred embodiments, which offer significant additional advantages. For example, in some embodiments, it is possible to use a membrane, which has a large electrostatic charge, for example, in the order of 500-2000 μC/m², because the vibration distance of the membrane can be easily controlled. The manufacturing method can also easily be applied in mass production while manufacturing costs remain low.

In the following, the invention is examined with the aid of examples and with reference to the accompanying drawings. The examples are in no way intended to restrict the scope of protection defined by the Claims.

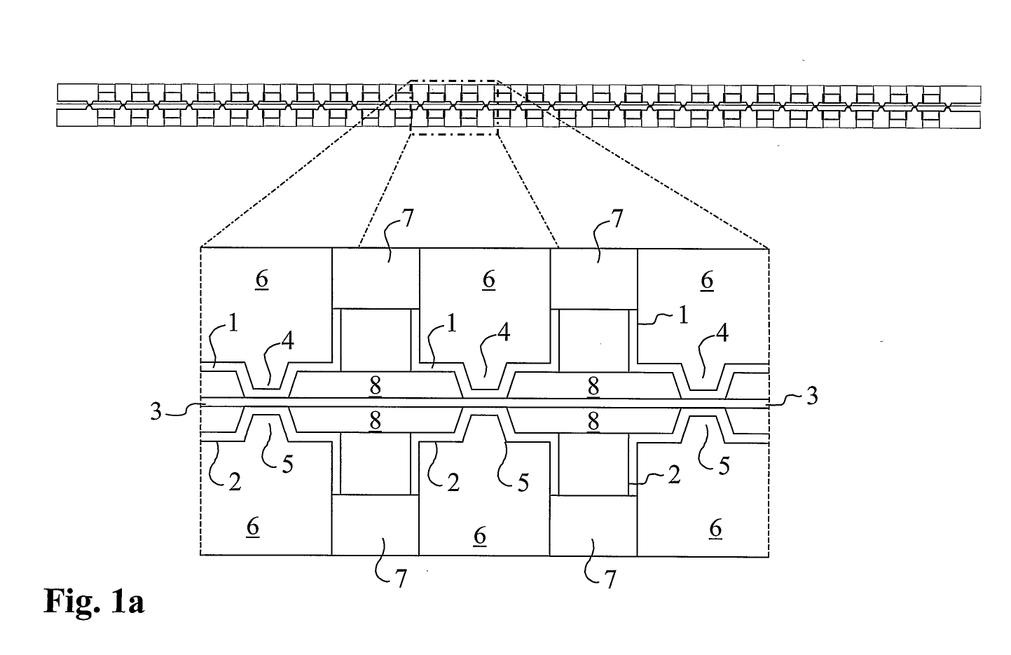

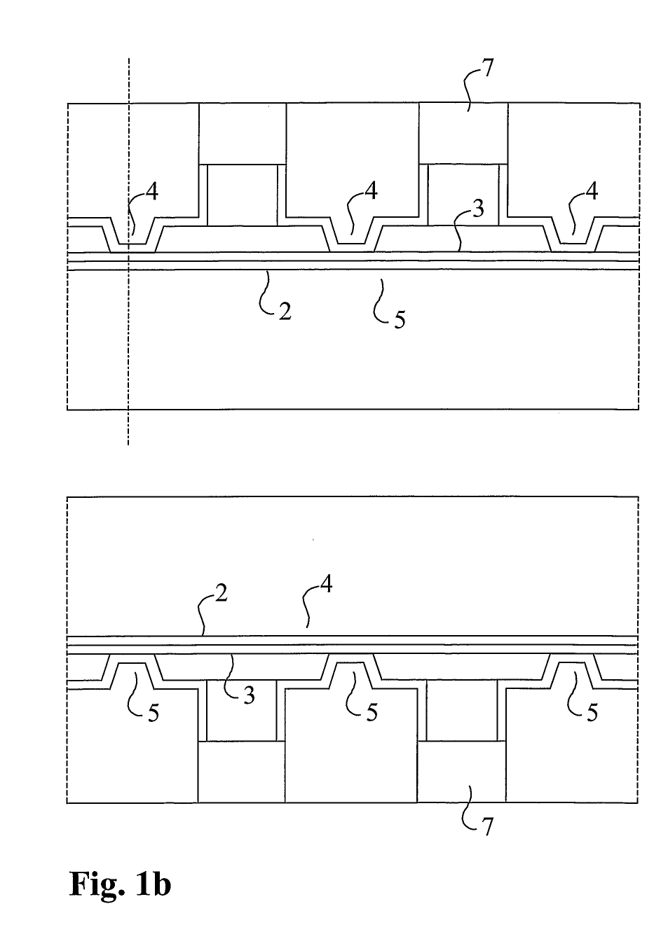

FIG. 1a shows a cross-section of one transducer according to the invention.

FIG. 1b shows a cross-section of transducer elements according to a second embodiment of the invention.

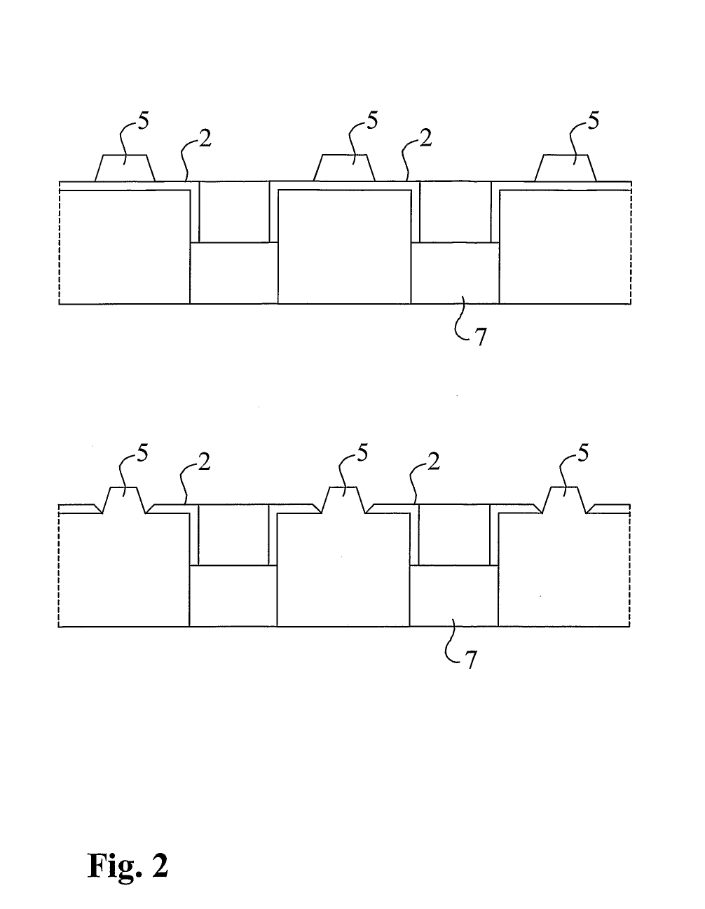

FIG. 2 shows cross-sections of two electrode and support structures, which are alternatives to the electrode and support structures shown in FIGS. 1a and 1b.

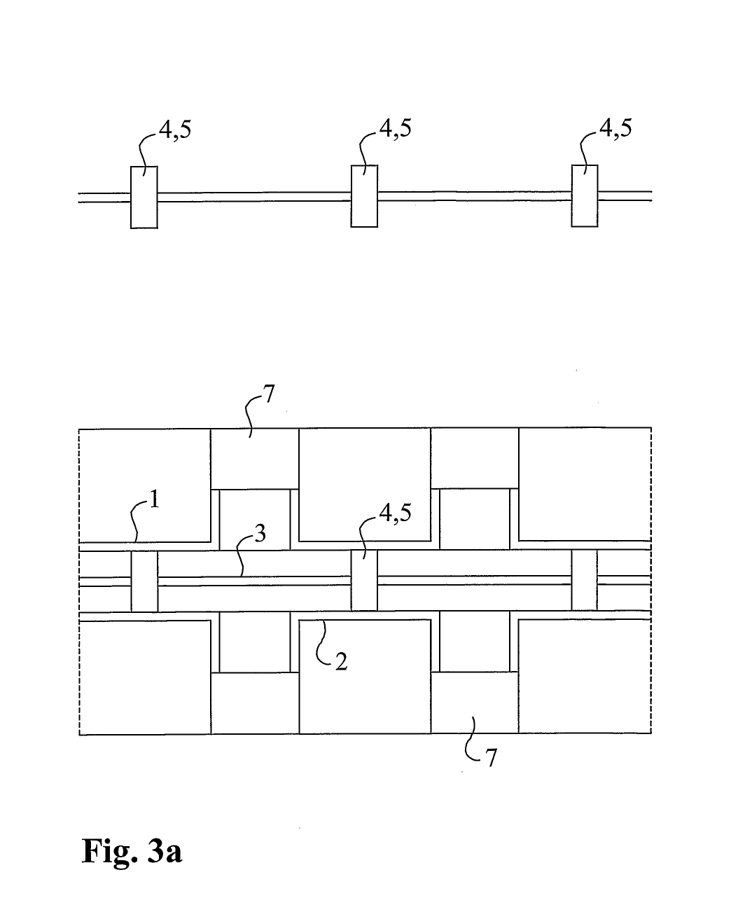

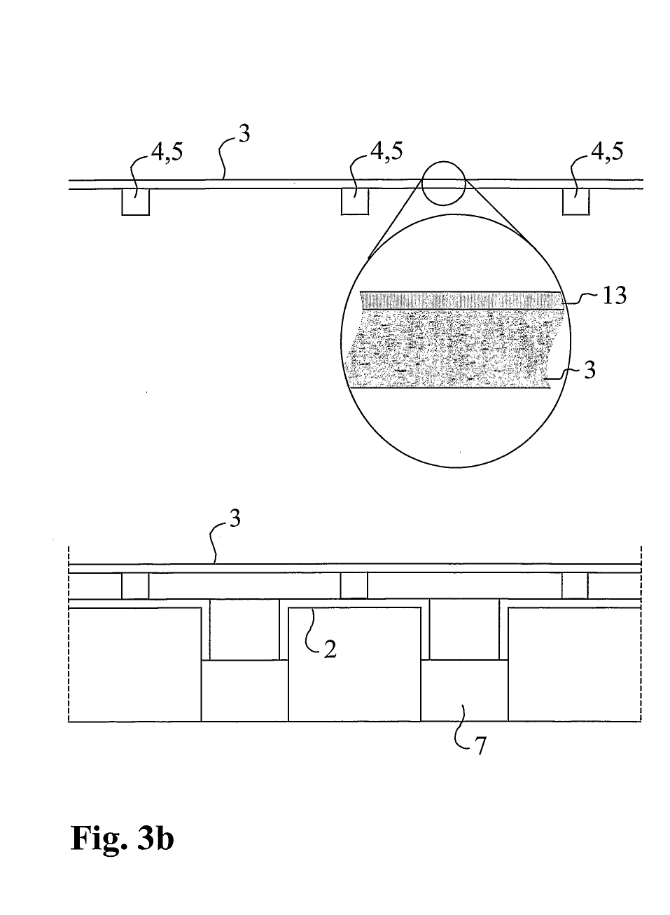

FIG. 3a shows cross-sections of one embodiment of the invention, in which the support structure of the membrane is manufactured as part of the membrane.

FIG. 3b shows cross-sections of a second embodiment of the invention, in which the support structure of the membrane is manufactured as part of the membrane.

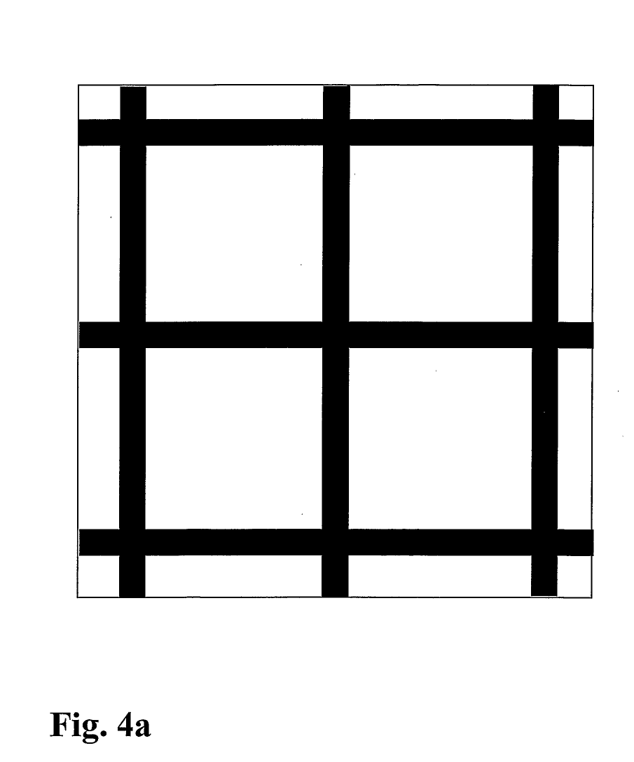

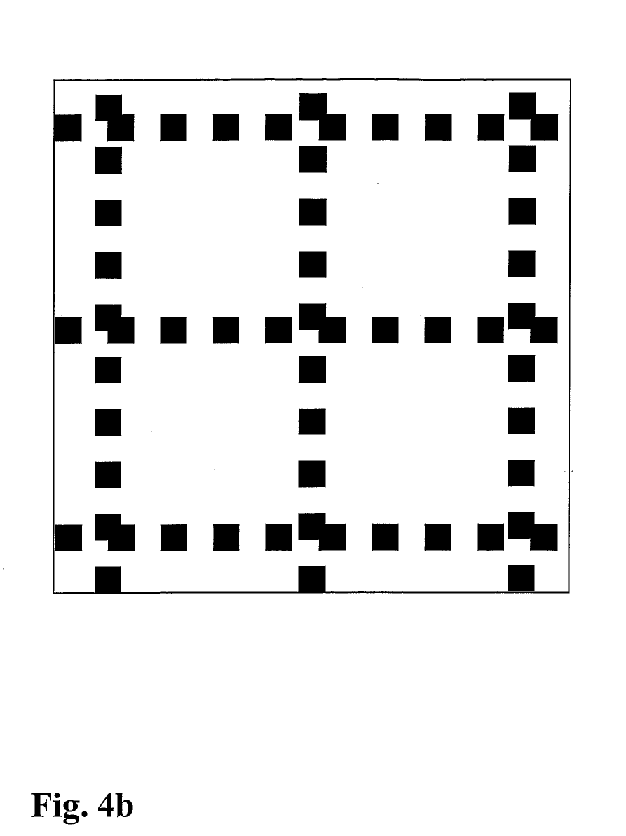

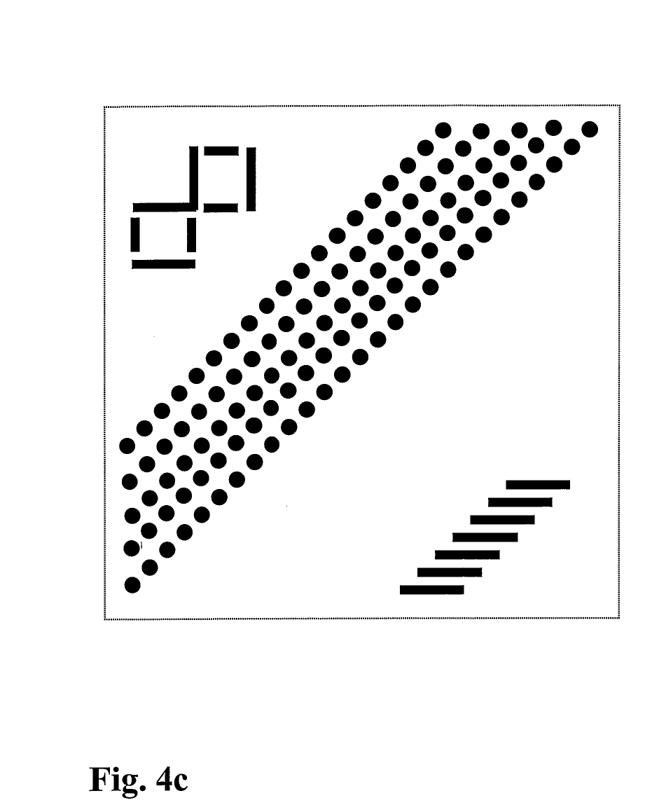

FIGS. 4a, 4b, and 4c show some alternative support-structure patterns, seen towards the surface of the membrane.

FIG. 1a shows a cross-section of the transducer, in which there are several parallel transducer elements (upper drawing). FIG. 1a also shows a cross-section of the transducer, in which two parallel transducer elements are shown in greater detail. The transducer elements of FIG. 1a include a membrane 3 arranged to vibrate, which is charged with the aid of a permanent charge and/or a bias voltage. The membrane is supported between the ridges 4 and 5, from several support points, so that several parallel vibrators are formed in the membrane 3. In the embodiment of FIG. 1a, the ridges 4 and 5 are elongated, so that they extend through the entire transducer, in a direction at right-angles to the surface of FIG. 1a. The ridges 4 and the ridges 5 of the counter-piece are aligned relative to each other in such a way that the ridges 4 and 5 are parallel and are located next to each other on opposite sides of the membrane 3. In the embodiment of FIG. 1a, the ridges 4 and 5 thus separate the parallel vibrators from each other, but in some embodiments the ridges 4 and 5 are in contact with at least some other vibrators. For example, this is the case in an embodiment, in which the ridges 4 and 5 form points. FIG. 1a can also be considered to show such an embodiment, if the ridges 4 and 5 are thought of as short in the direction at right-angles to the surface of FIG. 1a.

In the embodiment of FIG. 1a, the ridges 4 and 5 are formed in the body material 6, which can be, for example, a suitable plastic. The electrodes 1 and 2 are formed on the surface of the base material, by surfacing one side of the base material with a conductive layer, for example, a metal layer. Before surfacing, openings 7, which are located between the ridges 4 and 5, are made in the base material 6. According to the manufacturing technique, the openings 7 and the ridges 4 and 5 can also be manufactured in connection with the creation of the piece of base material 6.

The membrane 3 according to FIG. 1a is pressed between the ridges 4 and 5 from several support points, in such a way that the part of the membrane 3 remaining between the support points can vibrate freely. In order to permit vibration, the base material piece 6 includes recesses between adjacent ridges 4 and correspondingly between adjacent ridges 5. These recesses form vibration spaces 8, i.e. cavities, in the membrane 3. The cavities 8 are connected to the air space surrounding the base material piece 6 through openings 7, so that when the membrane 3 vibrates, the air pressure of the cavity 8 can equalize through the opening 7. This reduces the vibration resistance of the membrane 3. The openings 7 shown in FIG. 1a can also be replaced by other corresponding openings or channels, which are able to implement a corresponding function. In some embodiments, the openings 7 or corresponding channels can be closed with the aid of a flexible membrane. The flexible membrane will then prevent dirt and moisture from entering the cavity 8 and contact between the membrane 3 and the electrodes 1 and 2. The vibration of the flexible membrane according to the air pressure in the cavity 8, however, effectively equalizes the air pressure in the cavity and transmits sound from the membrane 3 to the surroundings of the transducer and vice versa.

In the embodiment of FIG. 1a, the electrodes 1 and 2 also extend to the inner surfaces of the openings 7. This can be achieved by using a suitable surfacing method. The extension of the electrode to the opening 7 is not, however, essential, but this feature can be used to increase the strength of the electrical field that can be directed to the membrane 3.

FIG. 1b shows two cross-sections of another embodiment, in which the base material pieces 6 and the electrodes 1 and 2 are manufactured in the same way as in the embodiment of FIG. 1a, but the ridges 4 and ridges 5 of the counter-piece are aligned relative to each other with the ridges 4 and 5 lying in different directions, for example, at right-angles to each other. In the embodiment of FIG. 1b, the ridges 4 and 5 thus only partly separate the parallel vibrators from each other. In the upper drawing of FIG. 1b, the cross-section is drawn along the ridges 5, so that in the cross-section the other side of the membrane 3 appears to be bounded by the cavities 8 between the ridges 4. However, the cavities 8 are connected to each other, at least on the side of one surface of the membrane, which can be seen in a cross-section (lower drawing 1b) made along a ridge 4.

In the embodiments shown in FIGS. 1a and 1b, the charged membrane 3 is fitted between two electrodes 1, 2. The ridges 4, 5 formed in the electrodes 1, 2 or in the base material pieces 6 form the support structures of the membrane 3, with the aid of which the membrane is pressed between the electrodes 1, 2. The ridges 4, 5 and the surface of the electrodes form a vibration space 8 for the charged membrane. The ridges, which form support structures, can be shaped as, for example, a column, a beam, or a net. However, the structure as such does not require the ridges or other support points to have any regular shape, instead the support points can also be located according to an irregular pattern. Some possible patterns are shown in FIGS. 4a, 4b, and 4c. Channels or openings 7 are also formed in the electrode.

In FIG. 1a, the ridges 4, 5 formed in the electrodes are arranged opposite to each other, so that the membrane 3 can vibrate in two directions at the same point on a plane parallel to the surface of the membrane 3. In FIG. 1b, the ridges 4, 5 formed in the electrodes, and the vibration spaces 8 of the membrane 3 are arranged at different points on a plane parallel to the surface of the membrane 3, so that membrane 3 can also vibrate in two directions, but at different points on the plane parallel to the surface of the membrane 3.

FIG. 2 shows alternative support and electrode structures, which can well be used to replace, for example, the electrode structure shown in FIGS. 1a and 1b. In the upper structure shown in FIG. 2, the ridges 5 are formed on the surface of the electrode 2, after the manufacture of the electrode 2. The support structures can be manufactured, for example, using known printing techniques, or etching techniques. In the lower drawing of FIG. 2, an electrode surfacing 2 is made only in the areas of the openings 7 and the cavities 8. Thus, there is no conductive layer on the surface of the ridges 5. When using a support and electrode solution according to such an embodiment, the membrane 3 of the transducer itself can also be conductive. If the electrodes 1 and 2 are in contact with the membrane 3, the conductivity of the membrane should be small, so as not to disturb the electrical operation of the transducer.

FIG. 3a shows another solution for creating the vibration spaces 8 and support structures of the membrane 3. In the solution of FIG. 3a, the support structure is made as part of the membrane. Thus, the surface of the base material piece 6 and the electrodes 1 and 2 can be smooth, which will facilitate manufacture of the electrodes. The upper drawing of FIG. 3a shows a membrane 3 according to this embodiment, which includes protrusions 4, 5, which correspond to the ridges 4, 5 of the previous embodiments. As in the previous embodiments, the protrusions or ridges 4, 5 can be elongated ridges, columns, beams, or protrusions of any shape whatever, which are able to support the membrane 3 between the electrodes 1, 2, in such a way as to permit vibration of the membrane and to make the structure sufficiently reliable mechanically.

FIG. 3b shows a one-sided solution for creating the vibration spaces 8 and support structures of the membrane 3. In the solution of FIG. 3b, the support structure is manufactured as part of the membrane 3, but only on one surface of the membrane. On the other surface of the membrane 3, a thin metal film 13 is manufactured, which can suitably be of aluminium or gold, for example. This metal film can act as one of the electrodes. The upper drawing of FIG. 3b shows such a membrane structure and an enlarged cross-section of the membrane structure. In the embodiment, the membrane 3 includes protrusions 4, 5, which correspond to the ridges 4, 5 of the previous embodiments. As in the previous embodiments, the protrusions or ridges 4, 5 can be elongated ridges, columns, beams, or protrusions of any shape whatever, which are able to support the membrane 3 against the surface of the electrode 2, in such a way as to permit vibration of the membrane and to make the structure sufficiently reliable mechanically. In the lower drawing of FIG. 3b, the membrane structure 3 is shown attached to the surface of one electrode 2. Thus, in this case, the first electrode 1 is manufactured on the opposite surface of the membrane 3.

The membrane structure according to the embodiment of FIG. 3b permits a very simple and economical transducer to be manufactured on nearly any surface, which includes a second electrode 2. With the aid of the embodiment, the transducer can also be made extremely thin. Such transducers are highly suitable for use, for example, in small electronic devices, so that the transducer can, for example, be attached directly to the device case.

FIGS. 4a, 4b, and 4c show examples of some suitable types of support structure. In the figures, the ridges or other support structures are shown in black. In the structure of FIG. 4a, the support structure is formed of beams, which are arranged as a grid on both sides of the membrane. In the examples of FIGS. 4b and 4c, the support structure is formed of differently shaped columns. The typical distance between the neighbouring support points formed by the ridges or other support structures is from 200 μm to 5 mm.

The electrode can be constructed from a material, which is sufficiently conductive, or which can be surfaced with a conductive material. The electrode structure should be able to transmit sound between the membrane and the environment. This is achieved, for example, by forming openings 7 in the structure. If the electrodes are of a flexible material, the transducer can be made in a three-dimensional form. It is possible to bend the transducer structure, as the vibrating membrane is formed of small parallel vibrators. The electrode can be, for example, a polymer membrane, with a thickness of, for example, 0.1-5 mm, surfaced with a conductive material.

The electrode of the transducer can be formed in the casing of a portable device, when the electrode advantageously forms part of the case. As stated above, a transducer structure formed from parallel elements can be bent, allowing a transducer according to a preferred embodiment to also be placed in a curved part of the case of a portable device case. This achieves a significant advantage in terms of the design and shaping of portable devices. This is because placing a sufficiently large planar transducer in a small portable device can impose significant restrictions on the design and shaping of the device. The transducer structure according to a preferred embodiment of the invention can, on the other hand, be integrated as part of a curved piece, such as the case structure of a mobile station. Similarly, the transducer can also be located in the case of a camera, or computer, or even of eyeglasses or a pen, or in some other structure. The transducer can thus be given nearly any shape at all, in order to fit it into the available space.

The dimensions, such as the thickness, of the electrode and the shape and size of the openings are determined on the basis of the available signal voltage, the mechanical properties of the membrane, and the magnitude of the charge. The choice of dimensions is also determined by the manufacturing process being used and its performance. The openings are positioned between the support structures, preferably in the middle of the space delimited by the support structure and the surface of the electrodes. The number, size, shape, and position of the openings are preferably such as permit the unrestricted vibration of the membrane, thus achieving a sufficiently powerful sound pressure. The construction of the stator electrode is such that as little sound energy as possible is absorbed into the structure. The diameter of the openings formed in the electrode can be, for example, between 10 μm and 2000 μm, in practice generally between about 200 μm and about 1000 μm.

The control voltage is brought to the electrodes, for example, over conductors made in the structures. Because the structure has a high impedance, in some embodiments a high contact resistance can also be permitted, which will allow various connection methods to be used in the manufacture of the transducer structure.

Embodiments are disclosed above, in which one electrode separate from the membrane is located on both sides of the membrane 3. The transducer can, however, also be constructed in such a way that a second electrode is formed on the surface of the vibrating membrane 3, by surfacing the membrane with a conductive material. Manufacturing the electrodes to be separate from the membrane 3 achieves, however, a wider vibration amplitude, so that in many embodiments it is preferable to manufacture two electrodes 1 and 2 that are separate from the membrane 3.

The support structure (for example, the ridges 4 and 5) need not be of a conductive material, nor do its surfaces require a conductive surfacing. The greatest height of the support structure is typically less than 1000 μm and in practical embodiments it is usually between 20 μm and 200 μm. The dimensions are determined according to the embodiment on the basis of the necessary sound pressure and the free movement of the membrane 3 that this requires.

Either a permanent charge is formed in the membrane 3, or else a bias voltage is connected to it in order to create a charge. In order to create the bias voltage, there is metallization or some other conductive structure inside the membrane or on its surface. In many embodiments, the membrane 3 can be a permanently charged insulating membrane made from a polymer. The thickness of the membrane is typically 2-200 μm.

The membrane can be attached to the electrode structure, for example, with the aid of an adhesive or ultrasound welding. The membrane can be suitably pre-tensioned. The membrane can also be charged, for example, with the aid of a corona discharge.

The transducer element can be manufactured, for example, in such a way that the first electrode is manufactured first. The electrode can be manufactured, for example, from insulating plastic by injection moulding. After this, the one surface of the plastic piece is surfaced to be conductive. The electrode can also be manufactured using some other method and from some other material, for example, by milling from a material, such as a metal, that is itself conductive. In the same connection, it is also possible to manufacture the second electrode, which forms a counter-piece to the first electrode.

Next, the vibrating membrane is manufactured. The membrane can be made, for example, by cutting it from a suitable membrane material. As such, the manufacture of the actual membrane is well known and suitable membrane material is available from a membrane supplier. Correspondingly, the electrodes can be ordered as ready-made pieces, so that the order of manufacture of the electrodes and the membrane is as such of no significance.

After this, the membrane is placed between the electrodes and the electrodes are pressed together using an appropriate force. If it is wished to ensure that the membrane will remain in place, the membrane can be glued to either or both of the electrodes, using an adhesive. The glue can be dosed, for example, on the surface of the ridges or other support points included in the electrodes or the membrane. Alternatively, the membrane can be connected to the electrode structure using some other method, for example, a thermo-compression or ultrasound welding method.

In some embodiments, the membrane is pre-tensioned by a specific amount, before the membrane is attached to the electrode and the electrodes are pressed together, so that the parallel vibrators formed in the transducer receive a corresponding pre-tension. The magnitude of the pre-tension can be used to affect the vibration properties of the transducer elements being formed. Once the membrane has been attached to the electrodes, the membrane can be charged, using a suitable charging method, for example with the aid of corona discharge. The charge can be positive or negative. A pre-charged membrane can also be used in the manufacture, in which case the charging stage will not be required. However, charging the membrane after attachment achieves a certain advantage. At least in some embodiments, it is then possible to improve the retention of the charge in the membrane during later manufacturing stages. This makes it possible to achieve a larger charge density in the membrane.

In the following stage, the permanently charged membrane-electrode manufacture is attached to a second electrode structure, which can be, for example, in the case of the device. The transducer structure disclosed above is then formed. If the second of the electrodes is made in the case of the device, for example, in the case of a mobile station, when the metallization of the electrode is carried out other necessary conductors and conductive patterns can also be made on the surface of the case. One example is the manufacture of an antenna is the same process stage.

In some embodiments, both electrodes are made in one piece, in such a way that the piece includes a first area for forming the first electrode and a second area for forming the second electrode. Further, the piece includes a flexible part, hinge, or similar between the first and the second areas, so that the first and second areas can be turned opposite to each other, to form a first and second electrode. The membrane can be located between these electrodes and, if necessary, be glued or otherwise attached to either of the electrodes. It is also possible to envisage one of the electrodes being manufactured in the case of the device, or attached to it with the aid of a membrane-electrode manufacture adapter connection, hinge, or similar, so that the membrane-electrode manufacture can be easily secured in place in the case of the device and, if necessary, also easily detached and replaced with a new one.

Embodiments of the invention, differing from those disclosed above, can also be envisaged within the scope of the invention. The dimensions referred to above are also by way of examples and depict structure suitable for specific embodiments—they are thus not intended to restrict the scope of protection of the invention stated in the Claims. More generally, the dimensions of the structure are specified on the basis of the available signal voltage, the mechanical properties of the membrane, and the magnitude of the charge. The choice of the dimensions is also affected by the manufacturing process used and its performance. Similarly, necessary changes are made in the details of the transducer and the manufacturing method, to suit the requirements of the application.

1. An electromechanical transducer for converting sound energy into an electric signal, or vice versa, which transducer includes a membrane (3), two electrodes (1, 2), the electric field between which can be controlled or measured, and a support structure (4, 5), on which the membrane (3) is arranged to vibrate, interacting with the electric field, and which support structure (4, 5) includes several support points (4, 5), which are positioned in such a way that several parallel vibrators are formed in the membrane (3), wherein the membrane (3) is arranged, with the aid of the support structure (4, 5), against one of the electrodes (1, 2), which is relatively rigid so that vibration mainly takes place in the vibrating membrane, while the said electrode remains essentially immobile, characterized in that the support structure (4, 5) is formed as a permanent part of the membrane (3).

2. A transducer according to claim 1, characterized in that the support structures (4, 5) and the electrodes (1, 2) delimit cavities (8) for the parallel vibrators on both sides of the membrane (3), so that the membrane (3) can vibrate in both directions from its rest position.

3. A transducer according to claim 2, characterized in that at least some of the cavities (8) are located essentially opposite to each other on both sides of the membrane (3), so that the transducer includes several vibrators, which are able to vibrate in two directions from the rest position of the membrane (3), in such a way that the vibrating surface area of the membrane (3) is essentially the same size and at the same point in the membrane (3), when the vibrator vibrates in the first direction and in the second direction.

4. A transducer according to claim 2, characterized in that at least one opening or channel (7) is connected to each cavity (8), by means of which the internal space of the cavity (8) is in a pressure-equalization connection with the air space outside the transducer, or at least with some other cavity (8).

5. A transducer according to claim 1, characterized in that at least one electrode (1) forms a fixed structure, to which the moving membrane (3) is fitted, so that the membrane and the electrode (1) are in contact with each other only through the support structures (4, 5).

6. A transducer according to claim 1, characterized in that the membrane is a permanently charged electromechanical insulating membrane, the thickness of which remains essentially the same when the membrane vibrates.

7. A transducer according to claim 1, characterized in that the support structure (4, 5), the membrane (3), and the first electrode (1) are permanently attached together to form one piece, for example, by gluing or welding, and this piece is set or pressed against the second electrode (2).

8. A transducer according to claim 1, characterized in that one of the electrodes (1) is manufactured on the surface of the membrane (3).

9. A transducer according to claim 1, characterized in that the membrane (3) includes a support structure (4, 5) only on one side of the membrane (3).

10. A transducer according to claim 1, characterized in that the transducer is attached as part of the device case and that the first electrode (1) is manufactured on the surface of the membrane (3), and the second electrode (2) is manufactured on the surface of the device case.

11. A transducer according to claim 1, characterized in that the membrane (3) is a permanently charged electromechanical insulating membrane.

12. A method for manufacturing an electromechanical transducer, which transducer includes a membrane (3), two electrodes (1, 2), the electric field between which can be controlled or measured, and a support structure (4, 5), on which the membrane (3) is arranged to vibrate, interacting with the electric field, and wherein the membrane (3) is arranged, with the aid of the support structure (4, 5), against one of the electrodes (1, 2), which is relatively rigid so that vibration mainly takes place in the vibrating membrane, while the said electrode remains essentially immobile, in which method:
the support structure (4, 5) is formed in such a way that it includes several support points (4, 5) at a distance from each other, and
the membrane (3), the electrodes (1, 2), and the support structure (4, 5) are positioned in such a way that several parallel vibrators are formed in the membrane (3),
characterized in that
a combination piece is manufactured, which includes the first electrode (1), the membrane (3), and the support structure (4, 5) of the membrane (3), and
after the manufacture of the combination piece, the membrane (3) is charged with an electrical charge.

13. A method according to claim 12, characterized in that the first electrode (1) is formed on the surface of the membrane (3).

14. A method according to claim 12, characterized in that the membrane (3) is stretched to a pre-tension before the attachment of the membrane.

15. A method according to claim 12, characterized in that the membrane (3) is an electromechanical insulating membrane (3), to which a permanent electrical charge is brought when the membrane is charged.

16. A method according to claim 12, characterized in that the manufacture of the combination piece comprises:
taking an electrode (1),
taking a membrane (3),
taking a support structure (4), which is either a separate support structure (4) or is permanently attached to the electrode (1) or the membrane (3),
attaching the electrode (1), the membrane (3), and the support structure (4) to each other, in such a way that the membrane (3) is at least partly located at a distance from the electrode (1), and
charging the attached membrane (3) with an electrical charge.

17. A method according to claim 16, characterized in that the electrode (1), the membrane (3), and the support structure (4) are attached to each other, in such a way that the membrane (3) receives a specified pre-tension.

18. A method according to claim 16, characterized in that the membrane (3) is an electromechanical insulating membrane (3), to which a permanent electrical charge is brought when charging the membrane.
